(19) United States
(12) Patent Application Publication
(10) Pub. No.: US 2019/0084130 A1
(43) Pub. Date: Mar. 21, 2019

(54) Hand Operated Gripping Tool

(71) Applicant: SMC Corporation Ltd., Leicester (GB)

(72) Inventor: Nigel Buchanan, Fife (GB)

(21) Appl. No.: 16/083,211

(22) PCT Filed: Mar. 7, 2017
(86) PCT No.: PCT/GB2017/050614

§ 371 Date: Sep. 7, 2018

(30) Foreign Application Priority Data
Mar. 7, 2016 (GB) 1603923.2

(51) Int. Cl. B25B 7/10; B25B 7/14

(52) U.S. Cl. CPC B25B 7/10; B25B 7/14

(57) ABSTRACT

Pliers comprising a head portion incorporating gripping faces within the opposing jaws for the clamping of the desired workpiece, pivotal handle portions and a sprung toothed link positioned between the handles. Bow shaped resilient portion or portions are usefully incorporated within either or both the jaw or handle portions, when the pliers are operated these resilient portions impart a useful superior sprung pressure upon the clamped workpiece by the gripping face of the jaws. The Jaws and bend promoting portion are contiguous with each individual handle and gripping portion. The jaws can further be usefully locked in the required clamping position upon the workpiece by a toothed sprung strut pivotally attached to the fixed handle and conveniently being locked or unlocked according to the locking switch pivotal within the opposing moving handle.

### FIELD OF INVENTION

The invention relates to hand operated gripping tools, gripping tools that are adjustable within the range of the jaws of the tool. One form of hand operated gripping tool is colloquially known as water pump pliers or of the locking type generally referred to as pliers or vice grip pliers as they are commonly known.

### BACKGROUND TO THE INVENTION

Existing Water Pump pliers have the common characteristic of jaws offset at an angle to the Plier handles and a pivot post, in the form of a bolt or rivet, mounted in the area rearward of the jaw on one of the handles and projecting through an elongate slot on the other handle. In such pliers, means for enabling selective spacing of the distance between the jaws is variously provided by spaced apart ridges or teeth along the inside long edge of the slot adapted for incremental selective binding engagement with the pivot post. Another well-known method of providing distance adjustment between the jaws in such pliers is the provision of spaced apart arcuate ridges on the interfacing surfaces adjacent to the pivot point. All such tools in order to be adjusted to the size of a particular workpiece to be gripped between the jaws, require a two-handed operation when the handles are pulled apart to permit a sliding action of the pivot post along the slot to move the jaws to approximately the desired workpiece size.

Further types of pliers are adapted to slideably close upon a workpiece in response to manual closing of the handles and, in response to contact with the workpiece, automatically lock against further sliding action by engaging suitable teeth and thereby shift from a sliding to a pivoting mode whereby continued exertion of manual force on the handles increases the gripping action upon the workpiece.

This gripping action upon the workpiece is a function of the relationship between the length of the operating handles and the length of the jaws pivoting around the pivot post typically in a ration of around 5:1 therefore a considerable portion of the torque applied to the operating handle or handles is required to grip the workpiece to be operated meaning the workpiece can seldom be operated by such a device if it is itself tight to operate. In certain circumstances, it would be a considerable advantage if the pliers could be locked upon the workpiece. The existing designs are unable to include this function.

The pivot post locking action, whether by spaced apart ridges, teeth, or arcuate ridges on the inwards facing surfaces means that the jaws/handles are seldom in the optimum position prior to the shift from sliding to a pivoting mode which results in a variable gripping action upon the workpiece.

Existing locking pliers such as US2015283681, US2015273664 comprise two robust handles connected to two robust jaws, and a locking mechanism connected to the two jaws. The handles can be squeezed to close the jaws. The locking member is attached to an over centre linkage which when utilized prevents the lower handle from pivoting from its closed configuration and until opened retaining the jaws in a closed position. The clamping width of the jaws is adjusted by an adjustment screw, the adjustment screw further determining the clamping pressure exerted upon the clamped workpiece. As the clamping pressure has to be pre-set it can take several attempts to correctly adjust the screw to the required position in order to clamp the workpiece the best way. The clamping width of the jaws once set by the adjusting screw is finite, any movement, vibration or relaxing of the clamped material normally results in the failure of the clamping action. This is most prevalent when the device is used to initially clamp bodywork parts during a panel beating process prior to welding or bolting the panels being worked on. Inadvertent over pressure applied by the clamping jaws usually results in damage or distortion of the clamped parts.

U.S. Pat. No. D742,194 shows a set of pliers having a toothed strut with a locking mechanism attached to one operating arm. As the arms are closed the teeth “ratchet” past the lock. As the operating arms are not designed to resiliently deform during robust operation, the toothed arc of the strut remains in substantially the same locking angle relative to the locking mechanism.

EP2818280 comprises pliers or clamps having a bow or arcuate portion to permit limited flexing of one of the handles. A pivotal strut is retained between the handles and the strut is slidably held in a channel within one handle and pivotally held within the other handle. The pivotal end of the strut has a toothed arc, which acts with a switched pawl to lock or unlock the handle positions relative to one another. Compression of the handles closes the gap between the fixed and moveable jaws, the moveable jaw sliding up a clamp bar portion until the jaws robustly contact the workpiece, the further operation of the handles resulting in the clamping of the workpiece, the resilient arcuate portion acting to impose a limited sprung grip upon the workpiece, further usefulness imported by the locking action of the pawl teeth within the strut arc teeth when the pawl is switched into its ratchet locking position retaining the handles substantially in their closed position providing a limited spring grip upon the workpiece. The arc of the toothed strut in conjunction with the corresponding toothed arc of the pawl being capable of compensating for the changes in angles of one handle relative to the other as the resilient portion flexes as differing pressures are applied to the handles during use, any normal locking switch being rendered suspect as the angle of one locking tooth to the other changing as the handle flexes, which may prevent the teeth interlocking sufficiently to provide a dependable locking mechanism.

It is an object of the invention to at least partially alleviate at least one of the abovementioned disadvantages or to provide an alternative to existing products.

### SUMMARY OF THE INVENTION

The invention provides hand operated gripping tool comprising a fixed jaw handle, a fixed jaw connected with said fixed jaw handle, a movable handle pivotally connected with said fixed jaw handle for pivoting movement relative to said fixed jaw handle, a movable jaw connected with said movable jaw handle and a biasing member between said fixed and movable handles, wherein said movable handle carries a fixed pivot pin that is freely slideable in a curved slot defined in said fixed handle, said pivot pin has a least one tooth engageable with teeth provided on said fixed handle within said slot and said biasing mechanism is configured to resist movement of said movable handle towards said fixed handle while said pivot pin is freely slideable in said slot, whereby, in use, a user applied force to move said fixed and movable handles together is initially resisted by said biasing mechanism causing said pivot pin to slide in said slot causing said movable jaw to pivot towards said fixed jaw guided by said slot until said pivoting movement of said movable jaw is resisted by a workpiece engaged between said fixed and movable jaws after which said movable handle pivots relative to said fixed handle to bring said at least one tooth on said pivot pin into engagement with said teeth in said slot to prevent further pivoting movement of said movable jaw.

Some examples further comprise a strut having a first end pivotally engaged with one of said movable and fixed handles and having a first side provided with a series of teeth and a locking switch pivotably connected provided with the other of said movable and fixed handles and having at least one tooth to engage said series of teeth.

In some examples said biasing member engages said locking switch to bias said locking switch towards said first side of said strut.

In some examples said biasing member comprises a spring and said strut extends through said spring.

In some examples said strut has a second side disposed opposite said first side and said handle to which said locking switch is pivotably connected is provided with a bearing surface engaging said second side to control pivoting movement of said strut when, in use, said whereby the relative orientation of said locking switch and strut is maintained during relative sliding movement of said struct and locking switch.

In some examples said locking switch further comprises a guide face and said guide face is configured such that pivotal movement of said locking switch by a user applied force to release said at least one tooth from engagement with said teeth on said strut causes said guide face to engage said strut to cooperate with said bearing surface to define a channel through which said strut slides guided by said bearing surface and guide face when, in use, said fixed and movable handles move away from one another.

In some examples said slot is provided has opposed sides provided with respective series of said teeth and said pivot pin has respective oppositely disposed teeth to engage said series of teeth.

Reference to the Drawings Following is a listing of the various components used in the best mode preferred embodiment and alternative embodiments. For the ready reference of the reader the reference numerals have been arranged in ascending numerical order.

| | |
|---|---|
| 1 | Locking Water Pump Pliers |
| 200 | Head Portion |
| 201 | Fixed Jaw |
| 202 | Moving Jaw |
| 203 | Gripping Face |
| 204 | Assembly Holes |
| 205 | Jaw Fulcrum Pin Retention Hole |
| 206 | Moving Jaw Outer Plate |
| 207 | Moving Jaw Inner Plate |
| 208 | Fixed Jaw Inner Plate |
| 209 | Fixed Jaw Outer Plate |
| 210 | Fixed Jaw Bar Portion |
| 211 | Fixed Jaw Toothed Slot |
| 212 | Fixed Jaw Slot Teeth |
| 300 | Handle Portion |
| 301 | Fixed Handle |
| 302 | Moving Handle |
| 303 | Handle Clenching Grips |
| 304 | Handle Bend Promoting Portions |
| 305 | Assembly Holes |
| 306 | Strut Pivot Pin Holes |
| 307 | Switch Pivot Pin Holes |
| 308 | Fixed Handle Inner Plates |
| 309 | Moving Handle Inner Plates |
| 310 | Moving Handle Outer Plates |
| 313 | Grip Covers |
| 400 | Pivotal Strut |
| 401 | Strut Toothed Face |
| 402 | Strut Teeth |
| 403 | Strut Back Face |
| 404 | Strut Pivot Pin Hole |
| 405 | Strut Outer End |
| 406 | Strut Stop |
| 500 | Pivotal Switch |
| 501 | Pivotal Actuator |
| 502 | Actuator Pivot Hole |
| 503 | Smooth Guide Portion |
| 504 | Spring Operating Face |
| 505 | Toggle Lever |
| 506 | Locking Teeth |
| 507 | Locking Stop |
| 508 | Pivotal Switch Housing |
| 509 | Housing Guide Block Face |
| 510 | Housing Strut Channel |
| 511 | Housing Spring Alignment Projection |
| 514 | Toothed Wheel Switch |
| 515 | Toothed Wheel |
| 516 | Toothed Wheel Axle |
| 517 | Actuator |
| 518 | Actuator Positional Arc |
| 519 | Positional Arc Locking Surface |
| 520 | Positional Arc Unlocking Surface |
| 521 | Actuator Spring Hole |
| 522 | Toothed Wheel Switch Housing |
| 523 | Toothed Wheel Switch Housing Pin Hole |
| 524 | Toothed Wheel Switch Housing Engagement Slots |
| 525 | Housing Outer Laminates |
| 526 | Housing Actuator Recess |
| 600 | Jaw Fulcrum Pin |
| 601 | Switch Pivot Pin |
| 602 | Strut Pivot Pin |
| 603 | Fixings |
| 604 | Jaw Fulcrum Pin Teeth |
| 605 | Jaw Fulcrum Pin Smooth Surface |
| 606 | Jaw Fulcrum Pin Retaining Profile |
| 607 | Switch Spring Retaining Pin |
| 70 | Strut Spring |
| 71 | Strut Spring Ends |
| 72 | Switch Spring |
| 80 | Workpiece |
| A | Initial Pivot Point |
| B | Secondary Pivot Point |
| X | Further Pivot Point |
| D | Final Pivot Point |
| C | Clenching Force |
| G | Gripping Force |

### DETAILED DESCRIPTION

A full and enabling disclosure of the invention including the best mode thereof, directed to one of ordinary skill in the art, is set forth in the specification, which makes reference to the appended drawings, in which:

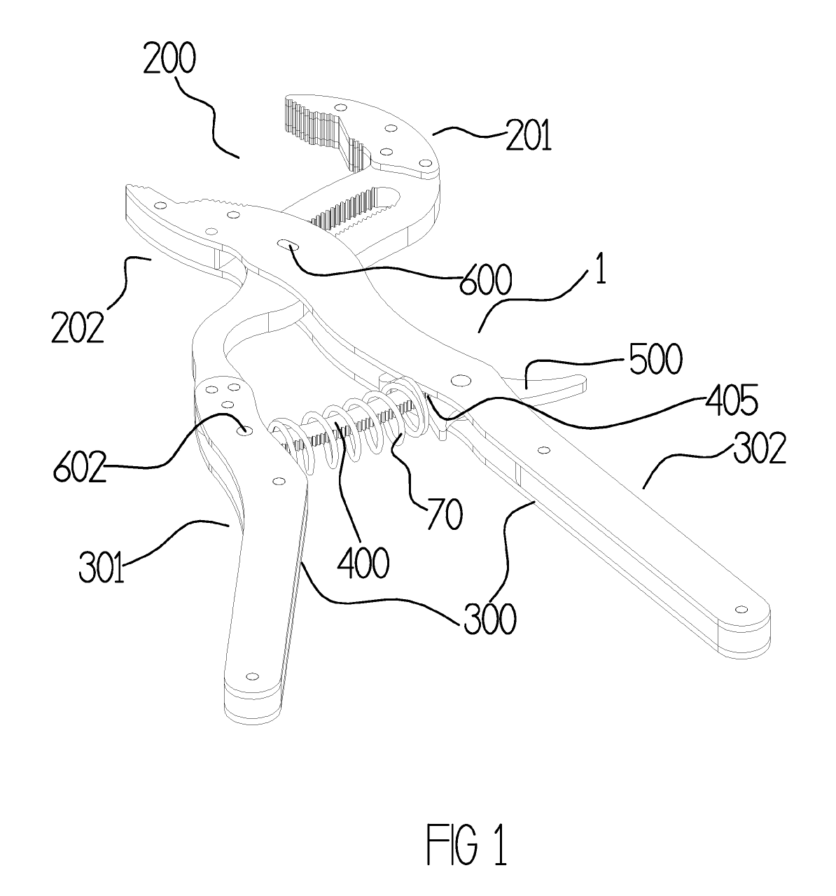

FIG. 1 is a perspective view of the Locking Water Pump Pliers.

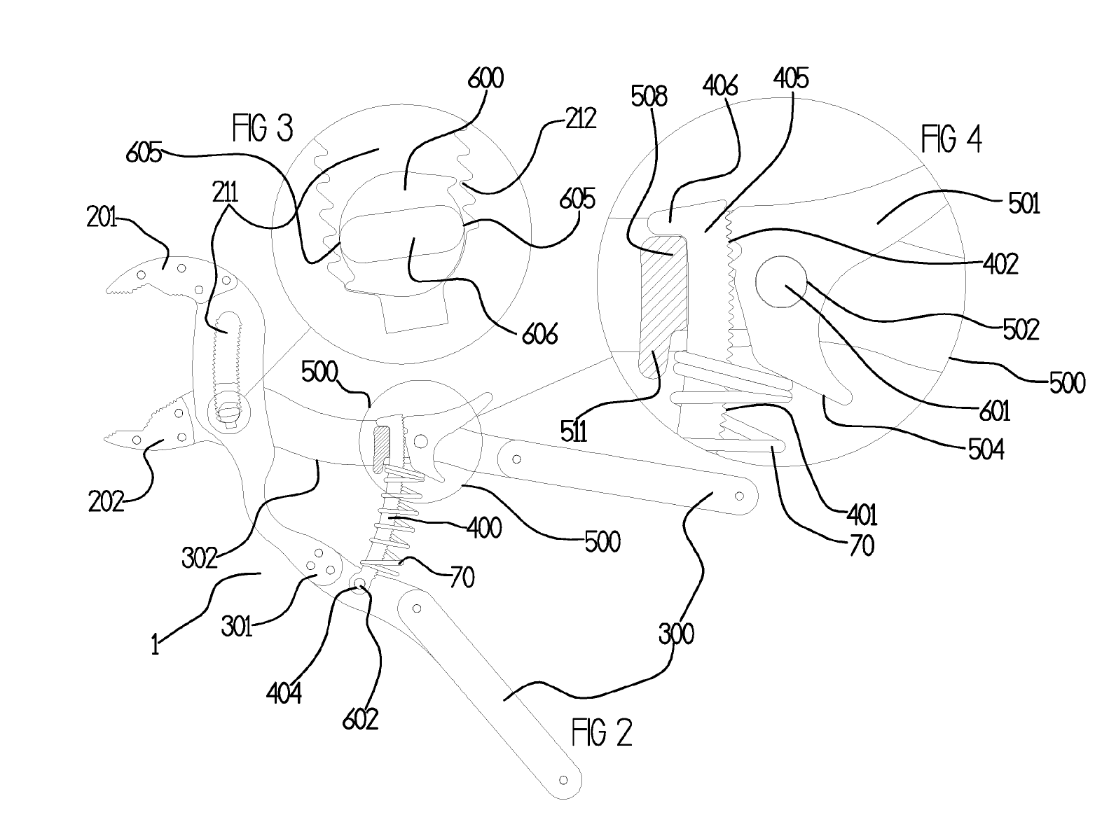

FIG. 2 is a plan view of the Locking Water Pump Pliers. The moving and fixed handle top plates and the cage switch top laminate shown removed for illustration purposes.

FIG. 3 is a close up view of the Jaw Fulcrum Pin at rest within the fixed jaw toothed slot.

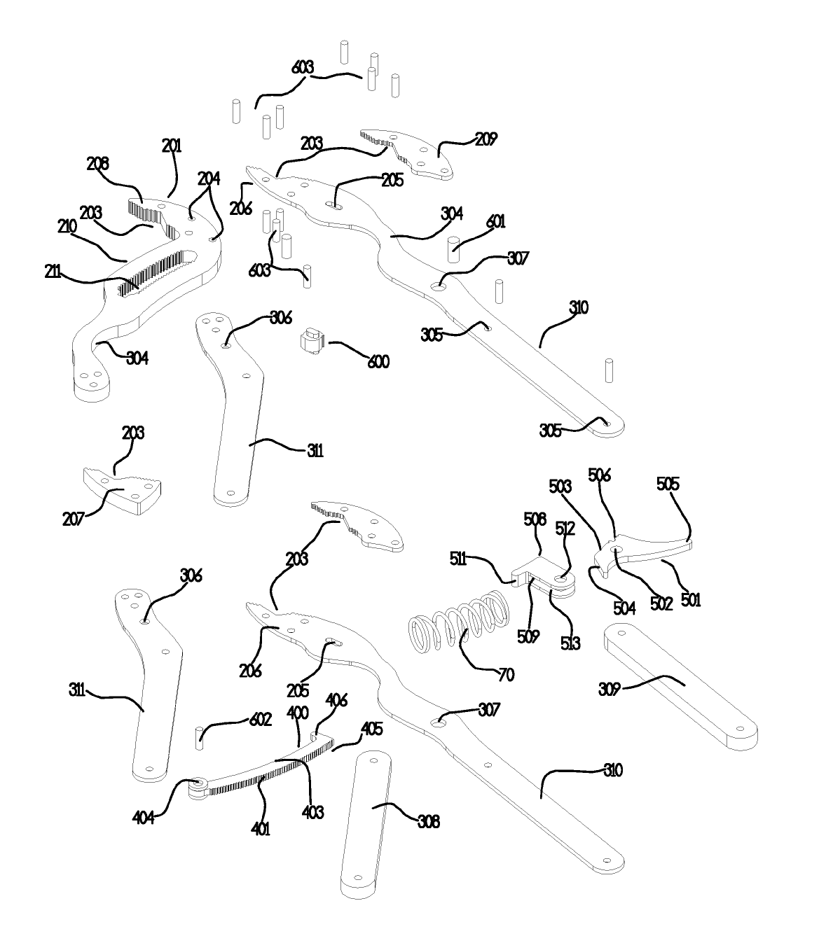

FIG. 4 is a close up view of the pivotal switch in the closed position, cage switch top laminate shown removed for illustration purposes.

FIG. 5 is a perspective view of the Locking Water Pump Pliers the parts shown dismantled for display purposes.

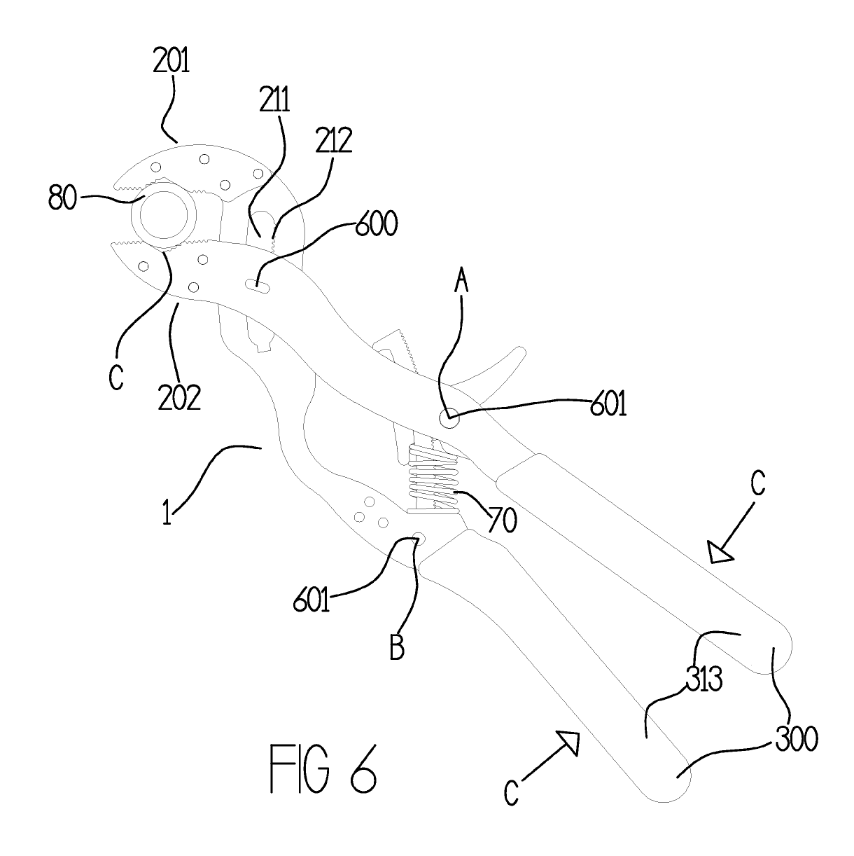

FIG. 6 is a plan view of the Locking Water Pump Pliers denoting the various pivot points in their alphabetical sequence of use. The moving handle pivoting around the switch pivot.

FIG. 7 is a plan view of the Locking Water Pump Pliers denoting the various pivot points in their alphabetical sequence of use. The sequence illustrated being the moving handle and jaw pivoting around the moving jaw gripping face.

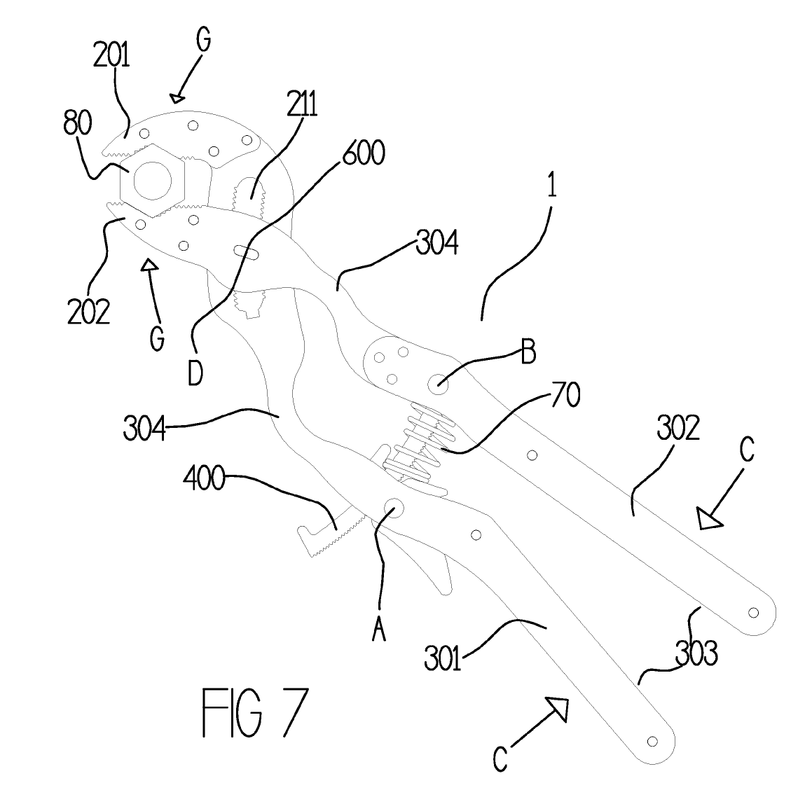

FIG. 8 is a plan view of the Locking Water Pump Pliers denoting the various pivot points in their alphabetical sequence of use. The sequence illustrated being the moving handle pivoting around the jaw fulcrum pin. The moving handle top plate is shown removed for illustration purposes.

FIG. 9 is a perspective view of the jaw fulcrum pin.

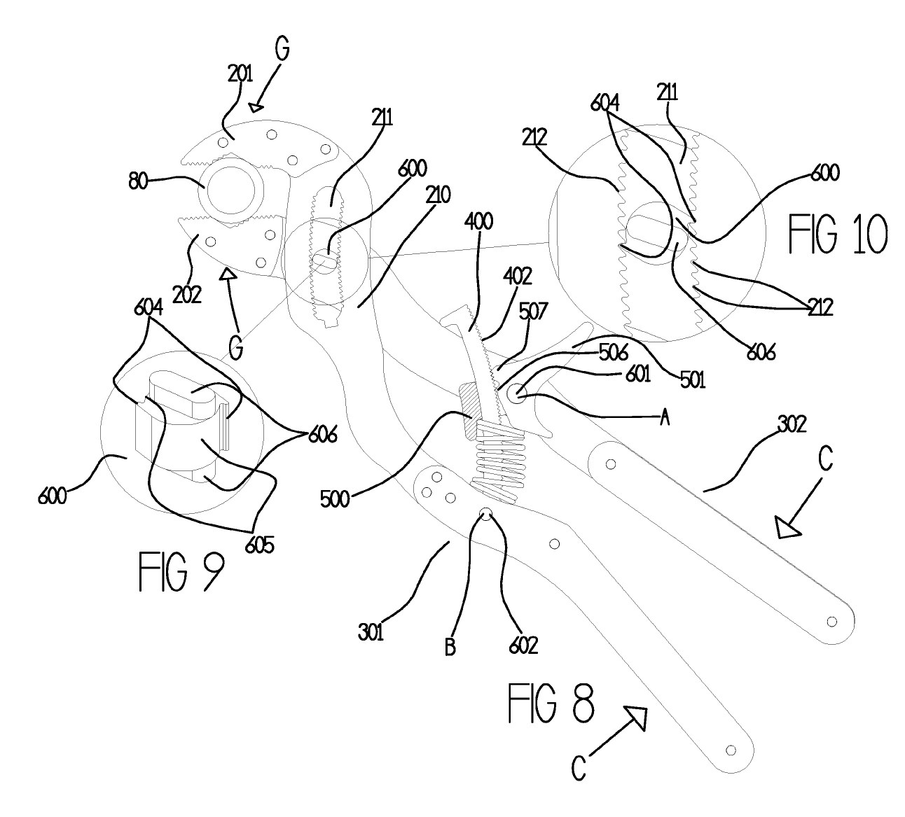

FIG. 10 is a plan view of the jaw fulcrum pin engaged within the fixed jaw toothed slot.

FIG. 11 is a plan view of the Locking Water Pump Pliers, the jaws locked upon a workpiece. The moving handle top plate is shown removed for illustration purposes.

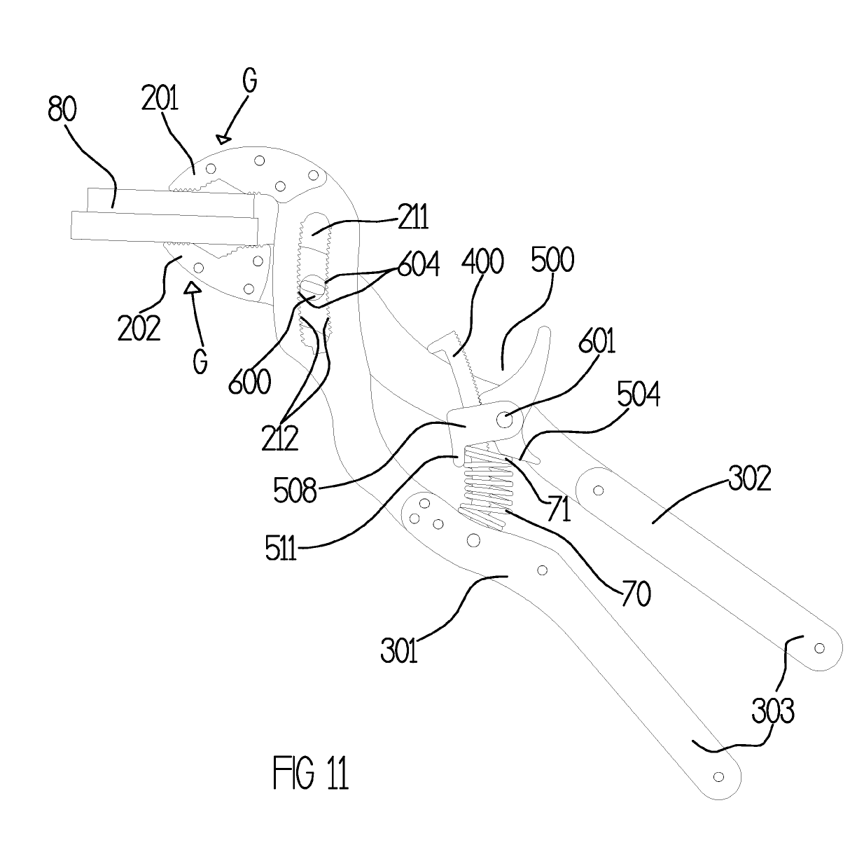

FIG. 12 is a plan view of the Locking Water Pump Pliers, the jaws encompassing a workpiece, the handle grips being first clenched whilst the switch toggle lever is operated thereby releasing the pliers grip. The moving handle top plate and switch top laminate are shown removed for illustration purposes.

FIG. 13 is a perspective view of a toothed wheel example of the pivotal switch, the parts shown dismantled for display purposes.

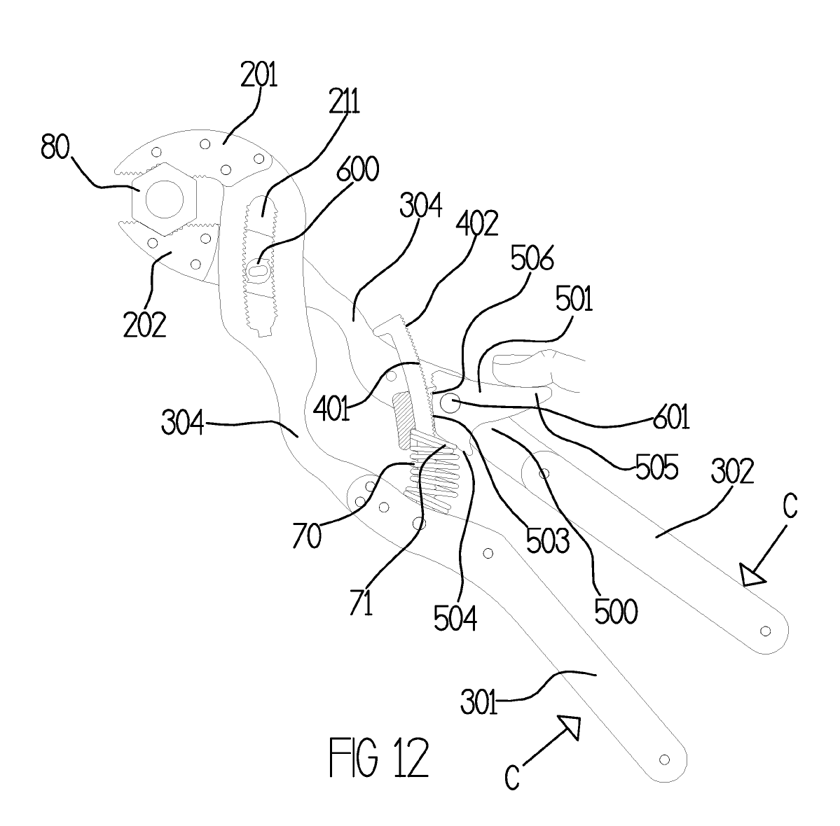

FIG. 14 is a plan view of the Locking Water Pump Pliers at rest, incorporating the further example of a pivotal switch. The moving handle top plate is shown removed for illustration purposes.

FIG. 15 is a close up plan view of the toothed wheel example of the pivotal switch as shown in FIG. 14, the top housing laminate removed for display purposes.

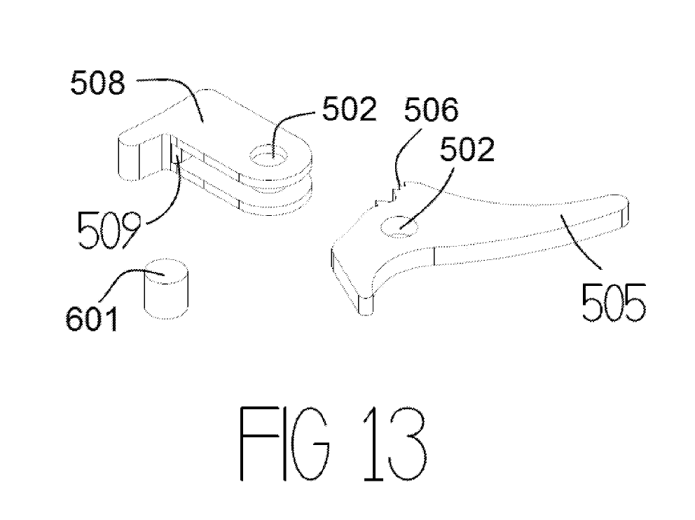

FIG. 16 is a plan view of the Locking Water Pump Pliers the switch further example being operated. The moving handle top plate is shown removed for illustration purposes.

FIG. 17 is a close up plan view of the toothed wheel example of the pivotal switch as shown in FIG. 16, the top housing laminate removed for display purposes.

### DETAILED DESCRIPTION

Referring to FIG. 1, the said Locking Water pump Pliers 1 comprising of a said moving jaw 202 contiguous to the said moving handle 302 and said fixed jaw 201 contiguous with the said fixed handle 301. The said head portion 200 and said handle portion 300 being pivotal around the said jaw fulcrum pin 600. A said pivotal strut 400 is illustrated pivotally held by a said strut pivot pin 602 within the said fixed handle 301 and further located within the said pivotal switch 500 at the said strut outer end 405, the said strut spring 70 encompassing the said strut 400 urging the said handles 300 apart.

Referring to FIGS. 2, 3 and 4 the said Locking Water pump Pliers 1 shown at rest are illustrated with the said moving handle top cover plate 310, said fixed handle top plate 311 and the said switch housing outer laminate 525 (not shown) removed for demonstration purposes. Comprising of a said moving jaw 202 contiguous to the said moving handle 302 and said fixed jaw 201 contiguous with the said fixed handle 301. The said head portion 200 and said handle portion 300 being pivotal around the said jaw fulcrum pin 600. A said pivotal strut 400 is illustrated pivotally held through its said pivot pin hole 404 by a said strut pivot pin 602 within the said fixed handle 301 and further located within the said pivotal switch 500 at the said strut outer end 405, the said strut spring 70 encompassing the said strut 400 urging the said handles 300 apart. FIG. 3 further shows in close up the said jaw fulcrum pin 600 within the said fixed jaw toothed slot 211 the said jaw fulcrum pin smooth surface 605 positioned adjacent to the said fixed jaw slot teeth 212, the said jaw fulcrum pin retaining profile 606 is also shown. FIG. 4 even further shows a close up of the said pivotal switch 500 illustrating the said pivotal actuator 501 pivotal around the said switch pivot pin 601 through the said actuator pivot hole 502 urged by the said strut spring 70 end 71 abutting the said spring operating face 504, the said housing spring alignment projection 511 ensuring the said correct pivotal contact between the said strut spring end 71 and the said actuator spring operating face 504. The said actuator locking teeth 506 engaged within the said strut toothed face 401, said teeth 402, the said strut stop 406 abutting the said pivotal switch housing 508 preventing the said handle portion 300 detrimentally opening too far.

FIG. 5 illustrates the said Pliers1, although the composition could consist of mainly cast or forged parts for example, for cost effectiveness the construction shown comprises a laminate assembly, whereas the parts are shown dismantled for display purposes. Comprising of a said fixed jaw 201, said inner plate 208 with a gripping face 203, said fixed jaw bar portion 210, said fixed jaw toothed slot 211, said fixing assembly holes 204, said fixed jaw outer plate 209, said jaw fulcrum pin retention hole 205, said moving jaw outer plate 206 and said moving jaw inner plate 207.

Said handle bend promoting portions 304, said assembly holes 305, said strut pivot pin holes 306, said switch pivot pin holes 307, said fixed handle inner plates 308, said moving handle inner plates 309, said moving handle outer plates 310 and said fixed handle outer plates 311. Said pivotal strut 400, said strut toothed face 401, said strut back face 403, said strut pivot pin hole 404, said strut outer end 405 and said strut stop 406.

Said pivotal switch actuator 501, said actuator pivot hole 502, said smooth guide portion 503, said spring operating face 504, said toggle lever 505, said locking teeth 506, said pivotal switch housing 508, said housing guide block face 509, said housing spring alignment projection 511, said housing pivot hole 512 and said housing actuator recess 513. Said jaw fulcrum pin 600, said switch pivot pin 601, said strut pivot pin 602, said fixings 603 and said strut spring 70.

Referring to FIG. 6, the said Locking Water pump Pliers 1 includes, a further sixth embodiment, comprising a closure sequence, whereas the actual pivotal locations change during the operation of the said handle portion 300 clenching. At rest the said handles 300 and said jaws 201, 202 are urged into their respective open positions by the said strut spring 70, when the said handles 300 are clenched the said moving handle 302 first pivots A approximately around the said switch pivot pin 601, the said jaw fulcrum pin 600 moving without difficulty up the said toothed slot 211 within the said fixed handle bar portion 210, the said adjacent smooth portions of the said jaw fulcrum pin 605 (not shown) presenting little resistance to the said toothed inner face of the slot 212. The strength of the said strut spring 70, usefully preventing undue compression during this action, the applied handle said clenching force C being directed towards the said moving jaw 202 being propelled towards the said fixed jaw 201, till it abuts the said workpiece 80 to be operated or clamped, situated between the said opposing jaws 201, 202. The said workpiece 80 now lightly grasped between the said moving 202 and said fixed jaws 201 changes the said moving handle 302 said pivot point A to that of the said moving jaw 202 to said workpiece 80 contact point C. The said pivotal strut 400 also slightly pivoting as required around the said strut pivot pin 601 at the said secondary pivot point B. Further shown are the said handles 300, said grip covers 313.

Referring to FIGS. 4, 7 & 10 the said Locking Water pump Pliers 1 includes, in the further sixth embodiment, comprising a closure sequence, whereas the said pivot point D is now the said jaw fulcrum pin 600. Whereas after the sequence described in the previous paragraph and in FIG. 6, any continued said moving handle 302, said pivotal clenching C motion further compresses the said strut 400 spring 70 and further rotates the said jaw fulcrum pin 600 within the said toothed slot 211 thereby engaging the said fulcrum pin toothed portion 604 into the corresponding said teeth 212 of the said toothed slot 211. This robust said toothed 604, 212 engagement now changes the said moving handle 302 pivot point D to that of the said jaw fulcrum pin 600. If further locking of the said jaws 201, 202 is required, any further robust said clenching C of the said handle grips 303 usefully bows the said bend promoting portions 304, the further locking action of the said switch locking teeth 506 upon the said toothed strut teeth 402 sustaining the said handles 301, 302 substantially in their closed position, the said bowed bend promoting portion or portions 304 exerting elastic potential energy to usefully spring said clamp G, the said workpiece 80 between the said opposing jaws 201, 202. The said pivotal switch 500 and said pivotal strut 400 further pivoting as required around their said pivot points A, B as the said bend promoting portions 304 flex. FIGS. 8, 9, 10 and 11 illustrate a further example of the invention said locking water pump pliers 1 wherein the said handles 301, 302 do not incorporate any said handle bend promoting portions 304. The said moving handle outer plate 206 (not shown) is removed for demonstration purposes. In all other respects the device is as illustrated in FIG. 7, the said moving handle top plate 310 and switch housing lamination 525 being removed for illustration purposes. The said pliers 1 are shown in the said clenched C position in FIG. 8 and locked position in FIG. 11, the said jaws 201, 202, said gripping G, the said workpiece 80, the said jaw fulcrum pin 600 rotated whereas its said teeth 604 are engaged within the corresponding said fixed jaw toothed slot 211 said teeth 212 within the said fixed jaw bar portion 210. The said pivotal switch 500, said pivotal actuator 501 said teeth 506 and said locking stop 507 (in this example shown toothed) engaged upon the said strut 400 said teeth 402 in a locking manner. The said handles 301, 302 remaining locked relative to one another within the said pivot points A (the said switch pivot pin 601), B (the said strut pivot pin 602), C (the said moving jaw gripping face 203 to said workpiece 80 contact) and D (the said jaw fulcrum pin 600). The said pivotal switch 500 said spring operating face 504 and corresponding said strut spring 70 said end 71 urging the said pivotal actuator 501 around the said switch pivot pin 601 as required. The said switch housing 508 said spring alignment projection 511 ensuring the correct pivotal force direction is applied to the said spring operating face 504. The said jaw fulcrum pin 600, said smooth surface 605 and said retaining profiles 606 are further illustrated.

Referring to FIG. 12 the said Locking Water pump Pliers 1 shown with the said moving handle top cover plate 310. Fixed handle top plate 311 and the said switch housing outer laminate 525 (not shown) removed for demonstration purposes. The said Jaws 201, 202, engaging a said workpiece 80 pivotal around the said jaw fulcrum pin 60. The said switch 500, said actuator 501, said toggle lever 505 is shown activated pivoting around the said switch pivot pin 601, the said spring operating face 504 further compressing the said strut spring 70 as it acts upon the said spring end 71, the said actuator smooth guide portion 503 now positioned against the said strut toothed face 401. The said handles 301, 302 having been clenched C in order to release the tension applied to the said locking teeth 506 upon the said strut teeth 402 by the elastic potential energy within the said bowed handle bend promoting portions 304.

FIG. 13 illustrates a further example of a said toothed wheel switch 514, whereas the parts are shown dismantled for display purposes. Comprising of a said housing 522 further comprising a said housing guide block face 509, said housing pivot hole 512, said spring pin holes 523, said toothed wheel engagement slots 524, and said outer laminates 525 having a generally central said actuator recess 513. The said actuator 517 further comprising a said pivot hole 502, said toggle lever 505, said spring hole 521, said positional arc 518, further comprising a said locking surface 519, either said toothed or smooth and smooth unlocking surface 520. The said toothed 526 wheel 515 in this example having a said separate axle 516, although it could be inclusive. The said switch spring 72 is also shown with its said retaining pin 607.

Referring to FIGS. 14, 16 the invention said Locking Water pump Pliers 1 shown locked and unlocked, are illustrated with the said moving handle top cover plate 310 and furthermore in FIGS. 15, 17 the said switch housing outer laminate 525 (not shown) removed for demonstration purposes.

The said toothed wheel switch 514 is illustrated in the locked or possible ratchet position in FIG. 15, the said toothed wheel 515 said teeth 526 engaged upon the said strut toothed face 401, the said positional arc locking surface 519 urged by the said switch spring 72 pivoting around the said switch pivot pin 601 and as shown in FIG. 14 the said toothed wheel axle 516 further illustrated propelled up the said housing engagement slots 524 towards the said strut 400. A said workpiece 80, shown gripped G between the said jaws 201, 202 pivotal around the jaw fulcrum pin 600.

FIG. 16, 17 further showing the said toothed wheel switch 514, said toggle lever 505 operated disengaging the said toothed wheel 515 from the said strut toothed face 401, the said toothed wheel axle 516 being urged down the said housing engagement slots 524 away from the said pivotal strut 400 by the said actuator 517 said positional arc unlocking surface 520.

The said strut spring 70 now propelling the said handles 301, 302 and said jaws 201, 202, towards their respective open positions. The said smooth guide portion 503 usefully part forming a said housing strut channel 510 through which the said pivotal strut 400 can reasonably traverse in the opening sequence.

In the following description of the embodiments like parts of the Locking Water pump Pliers will be referred to by the same reference numbers.

The first embodiment of the invention is the utilization a plurality of said bowed resilient portions 304 within both said handles 301, 302 providing superior constant said jaw 201, 202 clamping pressure of the said part or parts 80 clamped, whilst normally preventing surface damage to the said parts 80 clamped. The invention further works on a reasonable range of said workpiece 80 sizes and shapes whilst utilizing superior said sprung gripping force G of the said workpiece 80. Furthermore, the main parts are capable of being stamped in order to further reduce their manufacturing cost.

The invention further includes, in the second embodiment, a said compression spring 70 encompassing the said pivotal link 400, this said spring 70 conveniently propels the said handles 301, 302 towards their open position when the said switch 500 is unlocked and the said handles 301, 302 are relaxed. The said strong spring 70 further largely prevents lateral movement of the said moving handle 302 down the said pivotal strut 400 during the initial said clenching C of the said handles 301, 302, ensuring that the said moving handle 302 can usefully pivot around the said switch pivot 601 in the first instance until the said converging jaws 201, 202 both contact the said workpiece 70. The said spring 70 can be further usefully utilized to operate the said switch 500.

The invention even further includes, in the third embodiment, a said pivotal switch 500 whereas the said guide block 509 which is required to remain substantially opposite the said switch teeth 506 during use is incorporated within a said pivotal switch housing 508 instead of being typically statically affixed to the said handle outer plates 310.

The invention even further includes, in the third embodiment a said actuator 501 situated within the said switch housing 508, the said actuator 501 comprising a said toggle lever 505, a said toothed engagement portion 506, a said pivot bore 502, a said spring abutment face 504, said smooth guide portion 503 and a said locking stop portion 507.

The said housing 508 and its internal said pivotal switch actuator 501 both rotate according to the operated movement and angle of the said toothed strut 400. The said pivotal switch 500 pivoting as required around the said switch pivot pin 601 ensuring the said switch 500 remains in complete engagement and alignment with the corresponding said toothed strut 400 at all times, thereby ensuring positive engagement between the said teeth 402 of the said toothed strut 400 and the said teeth 506 of the said switch 500. The rotation of the said switch 500 with the said toothed strut 400 therefore being capable of compensating for the obscure changes in angles as one said handle 301, 302 pivots relative to the other and as the said handle bend promoting portions 304 flex as differing said pressures C are applied to the said handles 301, 302 during use, any normal prior art locking switch being rendered suspect as the angle of the said strut teeth 402 to the said switch teeth 506 and the said guide block 509 change as the said handles 301, 302 pivot and flex which can and does prevent the said teeth 402, 506 interlocking sufficiently to provide a dependable locking mechanism.

The said housing 508 integral said smooth guide block guide face 509 providing sufficient span against the opposing smooth surface of the said strut back face 403 to ensure the adjoining said surfaces 509, 403 remain substantially parallel in all situations.

When the said plier grips 303 are operated the said handles 301,302 are propelled towards one another, the said strut 400 being pivotal at the said fixed end 404 around its said pivot pin 602. The said strut locking teeth 402 semi-engaging the said actuator toothed engagement portion 506, this engagement of the said switch teeth 506 and the corresponding said toothed strut face 401 further rotating the said actuator 501 and its said corresponding teeth 506 out of engagement with the said strut engagement teeth 402 in a ratchet like manner, against the resilience of the said strut spring 70, the generally smooth said back face 403 of the said toothed strut 400 being robustly positioned opposite the said switch teeth 506 by the said switch housing guide block 509. When the required said gripping pressure G is attained and the said handle clenching grip pressure C is relaxed, the said resiliently bowed portions 304 move towards their initial pre-stressed position whereby the said actuator 501 is rotated within the said housing 508 by the said switch teeth 506 engagement with the said strut teeth 402 aided by the said corresponding strut spring 70. This action expediently engages the locking interaction between the said strut teeth 402 and the said switch teeth 506, the said locking stop 507 whether smooth or toothed preventing undue travel. The said clamping action G of the said jaws 201, 202 being determined by the remaining resilience of the said bowed portions 304, the elastic potential energy. The resultant said jaw resilient closing force G is largely proportional to the said force C applied to the said handles 301, 302 and the pivotal dimension ratio between the said handles 301, 302 dimension to the said jaw fulcrum pin 600 and the said jaws 201, 202 dimension between their workpiece 80 gripping point and the said jaw fulcrum pin 600 less any small losses incurred during the said switch 500 locking procedure.

The invention 1 even further includes, in the fourth embodiment, a more immediate said locking action pivotal switch 514 incurring minimal loss of elastic potential energy during the switching process, comprising a said switch housing 522 with said parallel outer laminates 525 through which are situated the said pivot pin holes 512, the said inner recess 513 or strut channel 510 incorporating the said guide block 509. The said housing recess 513 containing a said pivotal actuator 517 having a said internal arc 518 encompassing a corresponding said inner toothed wheel 515 with a said central axle 516, the said arc 518 having a said inner smooth unlocking surface 520 and a said opposite toothed or optionally smooth inner locking surface 519, the said actuator 517 pivotally operated by a said toggle lever 505 around the said switch pivot pin 601. The said toothed wheel 515 is able to traverse within the limitations of the retention of its said axles 516 within the said switch housing elongate slots 524. The said toothed wheel 515 being optimally kept in constant sprung engagement with the said corresponding teeth 402 of the said locking strut 400 by the said switch inner (toothed or smooth) locking surface 519, projecting the said toothed wheel 515 up the said angled elongate slots 524 towards the said strut teeth 402. The said axle 516 in best practice is robustly attached to the said toothed wheel 515 although it is not a requirement. The said axle 516 and its attached said toothed wheel 515 during the actuation of the said handles 301, 302 sequence C can freely rotate against the ratchet like action of the said optional sprung toothed locking surface 519 within the said switch internal arc 518 and restricted confines of the said elongate slots 524 within the said corresponding cage housing laminates 525. The said elongate slots 524 are set at an appropriate angle relative to the said locking strut teeth 402 such that, as the said handles 301, 302 are compressed in the final clenching C sequence the said toothed wheel 515 and its said axle 516 in one example rotate anti clockwise up the said elongate slots 524 away from any locking action upon the said toothed strut 400. When the said handle portions 300 gripping force C is released the said bowed portions 304 elastic potential energy causes the said toothed strut 400 to rotate the partially pre-engaged said toothed wheel 515 clockwise down the angled said elongate slot 524 within the said housing outer laminates 525 towards the said toothed strut teeth 402, until it is robustly wedged by the converging said elongate slot 524 angles upon the corresponding said toothed strut 400, locking the said handles 201, 202 and thereby said jaws 201, 202 closed upon the clamped said workpiece 80 in a usefully robust sprung gripping action G. In order to unlock the jaws 201, 202 the toothed wheels locked position within the elongate slot 524 can be usefully transmuted by the operation of the pivotal actuator toggle lever 505. The pivotal actuator 501 having an integral arc 518 unlocking surface 520 designed to act upon the periphery of the toothed wheel 515 yet not impede its rotation. The operation of the toggle lever 505 pivoting the pivotal actuator 517 around its switch pivot pin 601 bringing the smooth unlocking surface 520 of the positional arc 518 forcefully into contact with the toothed wheel 515 periphery in the release direction, as an inbuilt safety lock measure the handles 301, 302 must first be operated enough to relieve the locking force of the toothed wheel axle 516 within the elongate slots 524 upon the toothed strut 400, the simultaneous operation of the toggle lever 505 allowing a smooth unlocking action as the handle 301, 302 pressure C and therefore jaw clamping pressure G is further relieved.

When the said switch actuator 501 said toggle lever 505 is operated and the said switch actuator 501 swivels around its said pivot pin 601 disengaging the said switch teeth 506 from the said strut teeth 402, the said smooth guide portion 503 of the said actuator 501 is now in contact with the said strut teeth 402, furthermore the said actuator internal positional arc unlocking surface 520 now contacts the circumference of the said toothed wheel 515 urging the said toothed wheel 515 up the said elongate slot 524 away from the said teeth 402 of the strut 400 disengaging the said toothed wheel 515 from the said strut 400. The said strut 400 now being able to smoothly traverse within the said housing channel 510 in the release direction urged by the elastic potential energy of the said compressed spring 70 encompassing the said strut 400, as an inbuilt safety lock measure the said handles 301, 302 must first be operated enough to relieve the initial locking force of the said switch teeth 506 upon the said strut teeth 402, the simultaneous operation of the said switch toggle lever 505 allowing a smooth unlocking action as the said handle 301, 302 pressure and therefor said jaw clamping pressure G is further relieved.

As it is commercially prudent to have a clicking noise to accompany the said jaw 201, 202 closure and locking procedure the said pivotal actuator inner locking surface 519 can be further toothed, the interaction of the tooth or teeth 519 with the corresponding rotating said toothed wheel 515 providing a typical ratchet like sound.

The said invention 1 even further includes, a fifth embodiment, comprising a said jaw fulcrum pin 600 having a central circumference which is partially said toothed 604 and said partially smooth 605, its lateral ends incorporating said retention profiles 606 in order to affix and prevent the said jaw fulcrum pin 600 rotating within its attached said moving handle 302.

In order to attain the maximum leverage between the said handles 301, 302 and the said jaw 201, 202 the said jaw fulcrum pin 600 should be as near the gripping point of the said jaws 201, 202 as possible. To that end the said invention 1 has a said jaw fulcrum pin 600 that is partially said smooth 605 and partially said toothed 604, the said teeth 604 substantially identical to the said teeth 212 within the said toothed slot 211 within the said bar portion 210 of the said fixed handle 301, the corresponding said teeth 604, 212 capable of robust engagement when the said toothed portion 604 of the said fulcrum pin 600 meshes its said teeth 604 within the said toothed slot 211. The said partially toothed jaw fulcrum pin 600 has said retention profiles 606 on its lateral ends which are affixed within correspondingly profiled said 205 retention apertures in the outer plates of the said moving handle 310. In the non-operated mode, the moving handle 302 can pivot around the switch pivot pin 601 urged by the strong strut spring 70 acting on the swivel lock spring face 504 usefully opening or deactivating the jaws 201, 202 relative to one another. The said spring face 504 usefully incurring the predominance of the pre-compressed strut spring 70 sprung force by causing the said spring 70 to usefully distort at the point where the said spring face 504 abuts the said spring end 71 whilst the opposite circumference of the said spring end 71 is retained under negligible lateral spring force near the smooth strut back face 403 by the spring guide 511, the greater the strut spring 70 width the greater the pivotal leverage.

The said invention 1 also includes, a further sixth embodiment, comprising a closure sequence, whereas the actual pivotal locations change during the operation of the said handle clenching C. At rest the said handle 300 and said jaws 200 are urged into their respective open positions by the said strut spring 70, when the said handles 300 are clenched C, the said moving handle 302 first pivots around the said switch pivot pin 601, A, the said jaw fulcrum pin 600 moving without difficulty up the said toothed slot 211 within the said fixed handle bar portion 210, the said adjacent smooth portions 605 of the said jaw fulcrum pin 600 presenting little resistance to the said toothed inner face of the slot 212. The strength of the said strut spring 70 usefully preventing undue compression during this action, the said applied handle clenching force C being directed towards the said moving jaw 202 being propelled towards the said fixed jaw 201, till it abuts the said workpiece 80 to be operated or clamped, situated between the said opposing jaws 201, 202. The said workpiece 80 now lightly grasped between the said moving and fixed jaws 202, 201 changes the said moving handle 302 pivot point to that of the said moving jaw 202 to said workpiece 80 contact point X.

Continued said moving handle 302 pivotal motion, compresses the said strut spring 70 and further rotates the said jaw fulcrum pin 600 within the said toothed slot 211 engaging the said fulcrum pin toothed portion 604 into the corresponding said teeth of the toothed slot 212. This robust toothed engagement now changes the said moving handle 302 pivot point A, B to that of the said jaw fulcrum pin D. If further locking of the said jaws 201, 202 is required, any further robust clenching C of the said handle grips 303 usefully bows the said bend promoting portions 304, the further locking action of the said switch teeth 504 upon the said toothed strut teeth 402 sustaining the said handles 301, 302 substantially in their closed position, the bowed said bend promoting portion or portions 304 exerting elastic potential energy to usefully spring clamp G, the said workpiece 80, between the opposing jaws 201, 202.

The said invention 1 can further incorporate clamping widths within its specification that are automatically adjusted, the locking pressure can be further be usefully determined by the operator by the straightforward gripping pressure of the said handles 301, 302, the simple release of the said handles 301, 302 initiating the locking of the said jaws 201, 202 upon the said clamped parts 80.

Examples of the invention may include a set of pliers comprising a head portion incorporating gripping faces within the opposing jaws for the clamping of the desired workpiece, pivotal handle portions and a sprung toothed link positioned between the handles. Bow shaped resilient portion or portions are usefully incorporated within either or both the jaw or handle portions, when the pliers are operated these resilient portions impart a useful superior sprung pressure upon the clamped workpiece by the gripping face of the jaws. The Jaws and bend promoting portion are contiguous with each individual handle and gripping portion. The jaws can further be usefully locked in the required clamping position upon the workpiece by a toothed sprung strut pivotally attached to the fixed handle and conveniently being locked or unlocked according to the locking switch pivotal within the opposing moving handle.

Examples of the invention may include clamping widths within its specification that are automatically adjusted, the locking pressure can be further be usefully determined by the operator by the straightforward gripping pressure of the handles, the simple release of the handles initiating the locking of the jaws upon the clamped parts.

Examples of the invention may include a plurality of bowed resilient portions within either or both handles providing superior constant jaw clamping pressure of the part or parts clamped whilst normally preventing surface damage to the parts clamped. The invention further works on a reasonable range of workpiece sizes and shapes whilst utilizing superior sprung gripping force of the workpiece. Furthermore, the main parts are capable of being stamped in order to further reduce their manufacturing cost.

Examples of the invention may include a compression spring encompassing the pivotal link, this spring conveniently propels the handles towards their open position when the switch is unlocked and the handles are relaxed. The strong spring further largely prevents lateral movement of the moving handle down the pivotal strut during the initial clenching of the handle, ensuring that the moving handle can usefully pivot around the switch pivot in the first instance until the converging jaws both contact the workpiece. This spring can be further usefully utilized to operate the switch.

Examples of the invention may include a pivotal switch whereas the guide block which is required to remain substantially opposite the switch teeth is incorporated within a pivotal switch housing instead of being typically statically affixed to the handle outer plates.

Examples of the invention may include a swivel lock or actuator situated within the pivotal switch, the actuator comprising a toggle lever, a toothed engagement portion, a pivot bore, a spring abutment face, smooth guide portion and a spring stop portion.

The housing and its internal pivotal switch both rotate according to the operated movement and angle of the toothed strut. The pivotal switch pivoting as required around the switch pivot pin ensuring the pivotal switch remains in complete engagement and alignment with the corresponding toothed strut at all times, thereby ensuring positive engagement between the teeth of the toothed strut and the teeth of the switch. The rotation of the switch with the toothed strut therefore being capable of compensating for the obscure changes in angles as one handle pivots relative to the other and as the handle bend promoting portions flex as differing pressures are applied to the handles during use, any normal locking switch being rendered suspect as the angle of the strut teeth to the switch teeth and the guide block change as the handles pivot and flex which can and does prevent the teeth interlocking sufficiently to provide a dependable locking mechanism.

The housing integral smooth guide block guide face providing sufficient span against the opposing smooth surface of the strut back face to ensure the adjoining surfaces remain substantially parallel in all situations.

When the plier grips are operated, the handles are propelled towards one another, the strut being pivotal at the fixed end around its pivot pin. The strut locking teeth semi-engaging the swivel lock toothed engagement portion, this engagement of the switch teeth and the corresponding toothed strut further rotating the swivel lock and its corresponding teeth out of engagement with the strut engagement teeth in a ratchet like manner, against the resilience of the strut spring, the generally smooth back face of the toothed strut being robustly positioned opposite the switch teeth by the switch cage guide block. When the required gripping pressure is attained and the handle clenching grip pressure is relaxed, the resiliently bowed portions move towards their initial pre-stressed position whereby the swivel lock is rotated within the housing by the switch teeth engagement with the strut teeth aided by the corresponding strut spring. This action expediently engages the locking interaction between the strut teeth and the switch teeth, the locking stop whether smooth or toothed preventing undue travel. The clamping action of the jaws being determined by the remaining resilience of the bowed portions, the elastic potential energy. The resultant jaw resilient closing force is largely proportional to the force applied to the handles and the pivotal dimension ratio between the handles and jaws less any small losses incurred during the switch locking procedure, the pivot being the jaw fulcrum pin.

Examples of the invention may include a more immediate locking action pivotal switch incurring minimal loss of elastic potential energy during the switching process, comprising a switch housing with parallel outer laminates through which are situated the pivot pin holes, the inner recess or strut channel incorporating the guide block and the outer face incorporating a strut spring guide. The strut channel containing a pivotal actuator having an internal arc encompassing a corresponding inner toothed wheel with a central axle, the arc having an inner smooth unlocking surface and an opposite toothed inner locking surface, the actuator pivotally operated by a toggle lever around the switch pivot pin. The toothed wheel is able to traverse within the limitations of the retention of its axles within the switch housing elongate slots. The toothed wheel being optimally kept in constant sprung engagement with the corresponding teeth of the locking strut by the switch inner (toothed or smooth) locking surface, projecting the toothed wheel up the angled elongate slots towards the strut teeth. The axle in best practice is robustly attached to the toothed wheel although it is not a requirement. The axle and its attached toothed wheel during the actuation of the handles sequence can freely rotate against the ratchet like action of the sprung toothed locking surface within the switch internal arc and restricted confines of the elongate slots within the corresponding housing laminates. The elongate slots are set at an appropriate angle relative to the locking strut teeth such that, as the handles are compressed in the final clenching sequence the toothed wheel and its axle in one example rotate anti clockwise up the elongate slots away from any locking action upon the toothed strut. When the handle portions gripping force is released the bowed portions elastic potential energy causes the toothed strut to rotate the partially pre-engaged toothed wheel clockwise down the angled elongate slot within the cage housing outer laminates, towards the toothed strut teeth, until it is robustly wedged by the converging elongate slot angles upon the corresponding toothed strut, locking the handles and thereby jaws closed upon the clamped workpiece in a usefully robust sprung gripping action.

In order to unlock the jaws the toothed wheels locked position within the elongate slots can be usefully transmuted by the operation of the pivotal actuator toggle lever. The pivotal actuator having an integral arc unlocking surface designed to act upon the periphery of the toothed wheel yet not impede its rotation. The operation of the toggle lever pivoting the pivotal actuator around its switch pivot pin bringing the smooth unlocking surface of the positional arc forcefully into contact with the toothed wheel periphery in the release direction, as an inbuilt safety lock measure the handles must first be operated enough to relieve the locking force of the toothed wheel axle within the elongate slots upon the toothed strut, the simultaneous operation of the toggle lever allowing a smooth unlocking action as the handle pressure and therefor jaw clamping pressure is further relieved.

As it is commercially prudent to have a clicking noise to accompany the jaw closure and locking procedure the pivotal actuator inner locking surface can be further toothed, the interaction of the tooth or teeth with the corresponding rotating toothed wheel providing a typical ratchet like sound, the switch rotating as required around the switch pivot pin against the resilience of the strut spring.

Examples of the invention may include a jaw fulcrum pin having a central circumference which is partially toothed and partially smooth, its lateral ends incorporating retention profiles in order to affix and prevent the jaw fulcrum pin rotating within its attached moving handles. Whereas providing a method of automatically engaging teeth within a slot adjacent the jaw-pivot point. In order to attain the maximum leverage between the handles and the jaw the jaw fulcrum pin should be as near the gripping point of the jaws as possible. To that end the invention has a jaw fulcrum pin that is partially smooth and partially toothed, the said teeth substantially identical to the teeth within the toothed slot within the bar portion of the fixed handle, the corresponding teeth capable of robust engagement when the toothed portion of the fulcrum pin meshes the teeth within the said toothed slot. The partially toothed jaw fulcrum pin has retention profiles on its lateral ends which are affixed within correspondingly profiled retention apertures in the outer plates of the moving handle.

In the non-operated mode, the moving handle can pivot around the switch pivot pin urged by the strong strut spring acting on the swivel lock spring face usefully opening or deactivating the jaws relative to one another. The said spring face usefully incurring the predominance of the pre-compressed strut spring sprung force by causing the said spring to usefully distort at the point where the said spring face abuts the said spring end whilst the opposite circumference of the said spring end is retained under negligible lateral spring force near the smooth strut back face by the spring guide, the greater the strut spring width the greater the pivotal leverage.

Examples of the invention may include a closure sequence, whereas the actual pivotal locations change during the operation of the handle clenching. At rest the handle and jaws are urged into their respective open positions by the strut spring, when the handles are clenched the moving handle first pivots around the switch pivot pin, the jaw fulcrum pin moving without difficulty up the toothed slot within the fixed handle bar portion, the adjacent smooth portions of the jaw fulcrum pin presenting little resistance to the toothed inner face of the slot. The strength of the strut spring usefully preventing undue compression during this action, the applied handle clenching force being directed towards the moving jaw being propelled towards the fixed jaw, till it abuts the workpiece to be operated or clamped, situated between the opposing jaws. The workpiece now lightly grasped between the moving and fixed jaws changes the moving handle pivot point to that of the moving jaw to workpiece contact point.

Continued moving handle pivotal motion compresses the strut spring and further rotates the jaw fulcrum pin within the toothed slot engaging the fulcrum pin toothed portion into the corresponding teeth of the toothed slot. This robust toothed engagement now changes the moving handle pivot point to that of the jaw fulcrum pin. If further locking of the jaws is required, any further robust clenching of the handle grips usefully bows the bend promoting portions, the further locking action of the switch teeth upon the toothed strut teeth sustaining the handles substantially in their closed position, the bowed bend promoting portion or portions exerting elastic potential energy to usefully spring clamp the workpiece between the opposing jaws.

1. A hand operated gripping tool comprising:
a fixed jaw handle;
a fixed jaw connected with said fixed jaw handle;
a movable handle pivotally connected with said fixed jaw handle for pivoting movement relative to said fixed jaw handle;
a movable jaw connected with said movable jaw handle; and
a biasing member between said fixed and movable handles,
wherein said movable handle carries a fixed pivot pin that is freely slideable in a curved slot defined in said fixed handle, said pivot pin has a least one tooth engageable with teeth provided on said fixed handle within said slot and said biasing mechanism is configured to resist movement of said movable handle towards said fixed handle while said pivot pin is freely slideable in said slot, whereby, in use, a user applied force to move said fixed and movable handles together is initially resisted by said biasing mechanism causing said pivot pin to slide in said slot causing said movable jaw to pivot towards said fixed jaw guided by said slot until said pivoting movement of said movable jaw is resisted by a workpiece engaged between said fixed and movable jaws after which said movable handle pivots relative to said fixed handle to bring said at least one tooth on said pivot pin into engagement with said teeth in said slot to prevent further pivoting movement of said movable jaw.

2. A hand operated gripping tool as claimed in claim 1, further comprising a strut having a first end pivotally engaged with one of said movable and fixed handles and having a first side provided with a series of teeth and a locking switch pivotably connected provided with the other of said movable and fixed handles and having at least one tooth to engage said series of teeth.

3. A hand operated gripping tool as claimed in claim 2, wherein said biasing member engages said locking switch to bias said locking switch towards said first side of said strut.

4. A hand operated gripping tool as claimed in claim 2, wherein said biasing member comprises a spring and said strut extends through said spring.

5. A hand operated gripping tool as claimed in claim 2, wherein said strut has a second side disposed opposite said first side and said handle to which said locking switch is pivotably connected is provided with a bearing surface engaging said second side to control pivoting movement of said strut when, in use, said whereby the relative orientation of said locking switch and strut is maintained during relative sliding movement of said strut and locking switch.

6. A hand operated gripping tool as claimed in claim 5, wherein said locking switch further comprises a guide face and said guide face is configured such that pivotal movement of said locking switch by a user applied force to release said at least one tooth from engagement with said teeth on said strut causes said guide face to engage said strut to cooperate with said bearing surface to define a channel through which said strut slides guided by said bearing surface and guide face when, in use, said fixed and movable handles move away from one another.

7. A handheld griping tool as claimed in claim 1, wherein said slot is provided has opposed sides provided with respective series of said teeth and said pivot pin has respective oppositely disposed teeth to engage said series of teeth.
